(19) United States
(12) Patent Application Publication
(10) Pub. No.: US 2011/0109227 A1
(43) Pub. Date: May 12, 2011

(54) Target Exchange Type Plasma Generating Apparatus

(75) Inventor: Yuichi Shiina, Tokyo (JP)

(73) Assignee: Ferrotec Corporation, Chuo-ku, Tokyo (JP)

(21) Appl. No.: 12/736,308

(22) PCT Filed: Mar. 4, 2009
(86) PCT No.: PCT/JP2009/054015

§ 371 Date: Sep. 28, 2010

(30) Foreign Application Priority Data
Mar. 31, 2008 (JP) 2008-094418

(51) Int. Cl. H05H 1/24

(52) U.S. Cl. 315/111.21

(57) ABSTRACT

The objective of the present invention is to provide a target exchange type plasma generating apparatus in which the positions of two targets can be adjusted independent of each other. A target exchanging mechanism (6) of a plasma generating apparatus for generating plasma by vacuum arc discharge comprises a main holder (32) driven half a rotation by a main motor (M), containing sections (32a, 32b) arranged opposite to each other across the diameter of the main holder, auxiliary holders (16, 18) rotatably contained in the containing sections (32a, 32b), two auxiliary motors (M₁, M₂) for spinning the auxiliary holders, sliders (S₁, S₂) for vertically moving the auxiliary holders (16, 18) in the direction of the spinning shafts of the auxiliary holders, and targets (T₁, T₂) fitted to the auxiliary holders (16, 18). The positions of the targets (T₁, T₂) are exchanged by rotating the main holder (32) by half a rotation. When the main holder (32) is stationary, the targets (T₁, T₂) are driven so as to be rotated and vertically moved independent of each other to a discharge position and a polishing position.

### FIELD OF THE INVENTION

The present invention concerns a plasma generating apparatus that generates plasma by vacuum arc discharge. More specifically, it concerns a target exchange type plasma generating apparatus in which supply sources of vacuum arc plasma (henceforth referred to as “targets”) are multiply installed, and a target exchanging mechanism is comprised, in which the positions of the target that has been installed as an electrode at the electric discharge position and the target whose electric discharge surface has been polished at the polishing position are exchanged.

### BACKGROUND ART

It has been known that the surface characteristics of a solid are improved by forming a film on or injecting ions in the surface of the solid material in plasma. Films that were formed using plasma that includes metal and/or nonmetal ions strengthen the abrasion and corrosion resistances of solid surfaces, and are useful as protective films, optical thin films, and transparent electroconductive films among others. As a method to generate plasma that includes metal and/or nonmetal ions, there is a vacuum arc plasma method. In this vacuum arc plasma method, an arc spot is formed in a vicinity of the electric discharge surface, by an arc discharge that arises between the electric discharge surface of the target that is the cathode and the anode. The arc spot becomes self-sustaining upon supplying of a predetermined arc current, and vacuum arc plasma comprising ions of the target material (henceforth simply called “plasma”) is ejected from the arc spot. The arc spot becomes unstable when a hole formed by evaporation/weathering (erosion) of the target material exists on the electric discharge surface (henceforth referred to as “pore”), and a larger arc current becomes necessary to maintain the arc spot. Therefore, in a conventional plasma generator, when the electric discharge surface of a target became worn out by formation of pores, it was necessary to interrupt temporarily the intermittent generation of plasma, open the vacuum chamber, and exchange the target. To achieve the necessary degree of vacuum again, a time greater than 1 day was often necessary.

In the Japanese Patent Laid-Open No. 2005-240182 bulletin (Patent Document 1), a conventional target exchange type plasma generating apparatus is described, in which two targets are provided side-by-side to make a long, continuous use possible, and the positions of the target whose electric discharge surface became worn out by generation of vacuum arc plasma, and the target on which the polishing of the electric discharge surface has been completed, can be exchanged in the same vacuum chamber. FIG. 10 is a cross-sectional view of the conventional target exchange type plasma generating apparatus described in Patent Document 1. In the conventional target exchange type plasma generating apparatus 102, first target t₁ is arranged in plasma generating portion 104 where striker 120 has been set up, and second target t₂ is arranged in target polishing portion 108 where a polishing device comprising grinder g has been set up. Under a condition in which current flows between electric discharge surface T_{S1} of first target t₁ and striker 120 in contact with the former, generation of plasma is induced by separating striker 120 from electric discharge surface T_{S1}. That is to say, first target t₁ and second target t₂ are placed on holder 132 that comprises target exchanging means 106, first target t₁ is at the electric discharge position, and second target t₂ is at the polishing position. Said holder 132 comprises rotating shaft 148, and it can be rotated by means of rotating mechanism m. Therefore, the positions can be exchanged between first target t₁ depleted by generation of plasma, and second target t₂ that is unused, or on which trimming such as polishing treatment has been applied to electric discharge surface T_{S2}.
[patent document 1] Japanese Patent Laid-Open No. 2005-240182 bulletin

### DISCLOSURE OF THE INVENTION

### Problems to be Solved by the Invention

In the conventional target exchange type plasma generating apparatus shown in FIG. 10, the position of holder 132 set up on rotating shaft 148 was varied up or down by a single height control device 149, and the height positions of first target t₁ and second target t₂ were thus adjusted. Also, in a conventional target exchange type plasma generating apparatus same as FIG. 10, when first target t₁ and second target t₂ were spun, it was done by a single driving means. That is to say, it was impossible to change in an independent manner the height of the two targets in the electric discharge and the polishing positions, the contact position of striker 120 with respect to electric discharge surface T_{S1}, or the trimming position of electric discharge surface T_{S2}. Therefore, a fine adjustment according to the quantity of consumption of each target or the necessary arc current was not possible. However, because plasma is generated using either target necessarily, and a difference occurs between the quantities of consumption by the polishing treatment of the two targets, there was a demand for adjusting the height of multiple targets by raising and lowering them independently, and controlling the spinning of the targets. In particular, there were cases that a great difference occurred in the quantity of consumption of targets, when two kinds of targets with differing compositions were arranged.

Therefore, the object of the present invention is to offer a target exchange type plasma generating apparatus in which the positions of the targets in the electric discharge position and the polishing position can be exchanged, and the positions of the two targets can be adjusted independently.

### Means to Solve the Problem

The present invention has been proposed to solve the above problem, and the first form of the present invention is a target exchange type plasma generating apparatus comprising a plasma generating portion that generates plasma by a vacuum arc discharge between a target becoming a cathode and an anode under a vacuum environment, a target polishing portion that polishes an electric discharge surface of said target, and a target exchanging mechanism that exchanges the positions of a target positioned at an electric discharge position of said plasma generating portion and a target positioned at a polishing position of said target polishing portion, wherein said target exchanging mechanism comprises a main holder half-rotated by a main motor, two containing portions installed in opposite positions along the diameter direction of said main holder, two auxiliary holders contained rotatably in said two containing portions, two auxiliary motors spinning said two auxiliary holders, two sliders raising and lowering said two auxiliary holders in the spinning shaft direction, and said two targets engaged in said two auxiliary holders, where the positions of said targets are exchanged by half-rotating said main holder, and said two targets are independently driven so that they are raised, lowered, and spun to said electric discharge position and said polishing position when said main holder is stationary.

The second form of the present invention is the target exchange type plasma generating apparatus of the first form, wherein connecting means removable from said auxiliary holders are installed at tips of said spinning shafts, said auxiliary motors and said sliders are separated from said main holder at the detachment time of said connecting means, the positions of said targets are exchanged by half-rotating only said main holder that has received said auxiliary holders, said auxiliary holders are separated from said main holder by raising said spinning shafts at the engagement time of said connecting means, and each of said two targets are independently deployed at said electric discharge position and said polishing position.

The third form of the present invention is the target exchange type plasma generating apparatus of the second form, wherein said connecting means comprises a chuck mechanism.

The fourth form of the present invention is the target exchange type plasma generating apparatus of the first form, wherein said auxiliary holders are fastened to tips of said spinning shafts, each of said two targets are positioned independently at said electric discharge position and said polishing position by raising said spinning shafts and separating said auxiliary holders from said main holder, said auxiliary holders are contained inside said containing portions of said main holder by lowering said spinning shafts, and said auxiliary motors and said sliders are half-rotated as a whole upon exchanging the positions of said targets by half-rotating said main holder.

The fifth form of the present invention is the target exchange type plasma generating apparatus of any one of the first to fourth forms, wherein said plasma generating portion is positioned in a plasma generation chamber sealed by an electric discharge partition wall when said target is positioned at said electric discharge position, said target polishing portion comprising a polishing device is positioned in a target polishing chamber sealed by a polishing partition wall when said target is positioned at said polishing position, and grinding powder that is ejected by said polishing device from said target is sealed in said polishing chamber.

The sixth form of the present invention is the target exchange type plasma generating apparatus of any one of the first to fifth forms, wherein said plasma generating portion is formed inside of an electrically neutral outer wall and an anode inner wall installed at the inner side of said outer wall.

The seventh form of the present invention is the target exchange type plasma generating apparatus of the sixth form, wherein a target coil is positioned at the outer circumference of said outer wall tube at a vicinity position of said target, a filter coil is positioned at the plasma outlet side of said plasma generating portion, and a stabilizing magnetic field that is generated by said target coil is formed in reverse-phase (cusp) or in-phase (mirror) of a plasma advancing magnetic field that is generated by said filter coil.

The eighth form of the present invention is the target exchange type plasma generating apparatus of any one of said first to seventh forms, wherein a striker that induces an arc discharge on said electric discharge surface of said target is positioned at a vicinity of the target positioned at said electric discharge position of said plasma generating portion, said striker is rotated around a fulcrum by a rotating means, and abutting of said striker tip against said electric discharge surface is detected by measuring the torque reaction force on said striker.

### Effects of the Invention

According to the first form of the present invention, because said target exchanging mechanism comprises a main holder half-rotated by a main motor, two containing portions installed in opposite positions along the diameter direction of said main holder, two auxiliary holders contained rotatably in said two containing portions, two auxiliary motors spinning said two auxiliary holders, two sliders raising and lowering said two auxiliary holders in the spinning shaft direction, and said two targets engaged in said two auxiliary holders. Because of this, the positions of said targets can be exchanged by half-rotating said main holder, and at the same time, said two targets can be independently driven so that they are raised, lowered, and spun to said electric discharge position and said polishing position when said main holder is stationary. That is to say, the main holder and the auxiliary holder are comprised so that they are driven independently, and for each target, the positional relation with the striker in the plasma generating portion or the grinder in the target polishing portion can be set at a suitable position. Also, by spinning each target independently, the contact location of the striker and the electric discharge surface, as well as the position of trimming, can be adjusted appropriately. In addition, for the motor, various kinds of driving means, such as an electric motor and an air cylinder-driven actuator, can be used. Therefore, even when a difference occurs in the quantities of consumption by the polishing treatment of the two targets, these two targets can be arranged at positions suitable for vacuum arc discharge or polishing treatment, through a height adjustment in which the targets are independently raised and lowered. In addition, polishing treatment is a trimming of the electric discharge surface of an exhausted target in a configuration designed beforehand, and it includes various methods. For example, aside from grinding, a method such as electropolishing can be used.

According to the second form of the present invention, connecting means removable from said auxiliary holders are installed at tips of said spinning shafts, said auxiliary motors and said sliders are separated from said main holder at the detachment time of said connecting means, the positions of said targets are exchanged by half-rotating only said main holder that has received said auxiliary holders, and said auxiliary holders can be separated from said main holder by raising said spinning shafts at the engagement time of said connecting means. Therefore, the targets can be exchanged without half-rotating said spinning shaft, said auxiliary motors, and said sliders along with said main holder, and the structure of the main holder can be relatively simplified. Because of this, the durability of the apparatus can be improved.

According to the third form of the present invention, because said connecting means comprises a chuck mechanism, said auxiliary holders can be attached to and detached from the tips of said spinning shafts more reliably. That is to say, through opening and closing of the chuck mechanism, the auxiliary holders and the spinning shafts can be attached and detached by a comparatively simple operation.

According to the fourth form of the present invention, said auxiliary holders are fastened to tips of said spinning shafts, each of said two targets are positioned independently at said electric discharge position and said polishing position by raising said spinning shafts and separating said auxiliary holders from said main holder, said auxiliary holders are contained inside said containing portions of said main holder by lowering said spinning shafts, and said auxiliary motors and said sliders can be half-rotated as a whole upon exchanging the positions of said targets by half-rotating said main holder. Because said auxiliary holders are fixed at the tips of said spinning shafts, abrasion of mechanical parts and generation of impurities accompanying attachment and detachment of said spinning shafts and said auxiliary holders can be minimized. Also, just as in the first form, said two targets can be independently driven so that they are raised, lowered, and spun to said electric discharge position and said polishing position when said main holder is stationary.

According to the fifth form of the present invention, said plasma generating portion is positioned in a plasma generation chamber sealed by an electric discharge partition wall when said target is positioned at said electric discharge position, said target polishing portion comprising a polishing device is positioned in a target polishing chamber sealed by a polishing partition wall when said target is positioned at said polishing position, and grinding powder that is ejected by said polishing device from said target is sealed in said polishing chamber. Because of this, the plasma generating portion can be maintained in a cleaner state. That is to say, it is doubly shielded by the electric discharge partition wall and the polishing partition wall, and a clean state can be maintained for a longer time. Also, a receiving portion for collecting the grinding powder can be set up at the upper side of the main holder.

According to the sixth form of the present invention, because said plasma generating portion is formed inside of an electrically neutral outer wall and an anode inner wall installed at the inner side of said outer wall, the safety of the plasma generating apparatus can be improved. That is to say, voltage is not applied on the outer wall of the plasma generating apparatus, and handling of this apparatus can be done relatively safely.

According to the seventh form of the present invention, a target coil is positioned at the outer circumference of said outer wall tube at a vicinity position of said target, a filter coil is positioned at the plasma outlet side of said plasma generating portion, and a stabilizing magnetic field that is generated by said target coil is formed in reverse-phase (cusp) or in-phase (mirror) of a plasma advancing magnetic field that is generated by said filter coil. Because of this, the plasma stabilization or the generation efficiency of plasma can be improved appropriately. There are cases where the generated vacuum arc oscillates on the electric discharge surface and becomes unstable, but results have been obtained where the vacuum arc is stabilized by application of a reverse-phase (cusp) magnetic field with respect to the plasma magnetic field, and plasma can be generated more stability. Also, when an in-phase (mirror) magnetic field is formed, the generation efficiency of the plasma can be improved.

According to the eighth form of the present invention, a striker that induces an arc discharge on said electric discharge surface of said target is positioned at a vicinity of the target positioned at said electric discharge position of said plasma generating portion, said striker is rotated around a fulcrum by a rotating means, and abutting of said striker tip against said electric discharge surface is detected by measuring the torque reaction force on said striker. Because of this, polishing treatment can be done highly efficiently. Previously, there were many cases where the striker came in contact with the electric discharge surface by the gravity or the inertia from a force applied at the time of drive, but by holding a constant torque and measuring the torque reaction force at the time of contact, the contact by the striker can be detected highly accurately.

### BRIEF DESCRIPTION OF THE DRAWINGS

FIG. 1 is a schematic cross-sectional view of a target exchange type plasma generating apparatus concerning the present invention.

FIG. 2 is an apparatus schematic cross-sectional view of the target exchange type plasma generating apparatus concerning the present invention, in a case that two auxiliary holders are received into a main holder.

FIG. 3 is an apparatus schematic cross-sectional view of the target exchange type plasma generating apparatus concerning the present invention, in a case that two holders are fixed to each spinning shaft.

FIG. 4 is an apparatus schematic cross-sectional view of the target exchange type plasma generating apparatus of FIG. 3, in a case that the auxiliary holders are received in the main holder.

FIG. 5 is a schematic cross-sectional view of the periphery of plasma generating portion 4 of the target exchange type plasma generating apparatus concerning the present invention.

FIG. 6 is a schematic cross-sectional view of a plasma processing apparatus to which the target exchange type plasma generating apparatus concerning the present invention has been set up.

FIG. 7 is an explanatory drawing of a movement process in the target exchange type plasma generating apparatus concerning the present invention.

FIG. 8 is an explanatory drawing of a movement process in the target exchange type plasma generating apparatus concerning the present invention.

FIG. 9 is an explanatory drawing of a movement process in the target exchange type plasma generating apparatus concerning the present invention.

FIG. 10 is a cross-sectional view of a conventional target exchange type plasma generating apparatus.

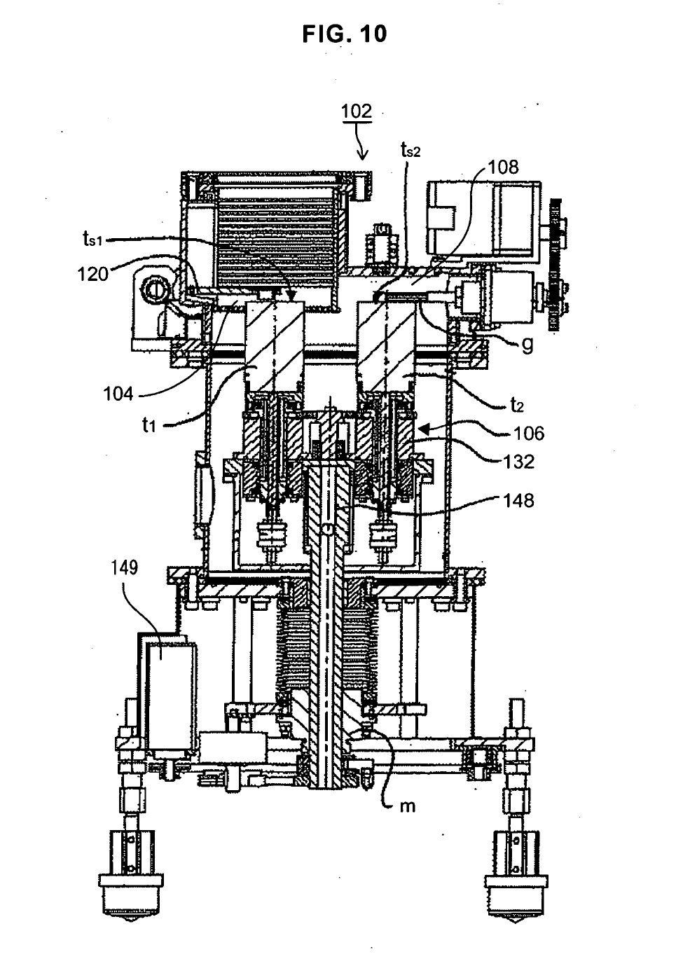

### BEST MODE FOR CARRYING OUT THE INVENTION

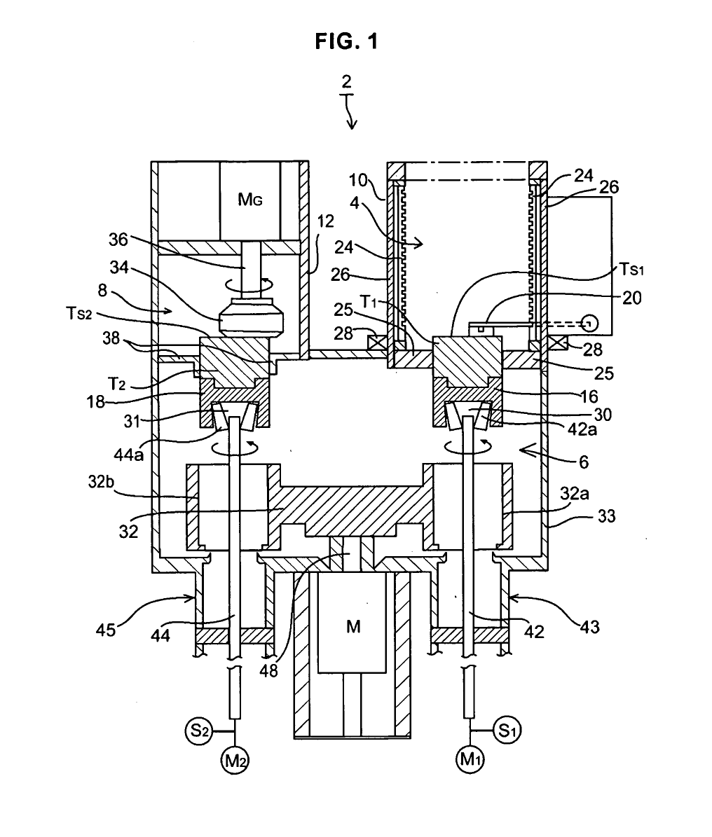

FIG. 1 is a cross-sectional view of target exchange type plasma generating apparatus 2 concerning the present invention. Target exchange type plasma generating apparatus 2 concerning the present invention comprises plasma generating portion 4 that has the electric discharge surface of the first target, target polishing portion 8 that has electric discharge surface T_{S2} of second target T₂, and target exchanging mechanism 6 that exchanges these targets. At plasma generating portion 4, when striker 20 is separated from electric discharge surface Tₛ₁ of target T₁ as a step previous to generating vacuum arc plasma between electric discharge surface T_{S1} of target T₁ and anode inner wall 24, an electric spark arises, inducing generation of plasma. Although not shown, in striker 20, a measuring means is set up for measuring the torque reaction force by rotating this striker 20 around the fulcrum, enabling the detection of the tip of striker 20 abutting against electric discharge surface T_{S1}. In addition, a pore is formed by electric discharge surface T_{S1} when plasma is generated. That is to say, target material in the pore evaporates, and forms plasma. Furthermore, plasma generating portion 4 is covered with outer wall 26, and target coil 28 that generates the stabilizing magnetic field described later is installed.

In said target polishing portion 8, grinder 34 is connected to a driving means, namely motor M_{G} for the grinder, through grinder rotating shaft 36, and electric discharge surface T_{S2} of target T₂ can be polished by grinder 34. By doing a polishing treatment on electric discharge surface T_{S2} with target polishing portion 8, it can remove the pores of electric discharge surface T_{S2} formed by generation of plasma. Furthermore, target polishing portion 8 is covered with polishing portion outer wall 12 and polishing partition wall 38, and even when polishing treatment is done on electric discharge surface TS2, ejection of grinding powder and such from target polishing portion 8 to another location in the vacuum chamber can be prevented or suppressed.

Target exchanging mechanism 6 of FIG. 1 is installed inside outer wall 33 of the vacuum chamber, and it comprises main holder 32 driven to half-rotation by main motor M, first containing portion 32a and second containing portion 32b installed in opposite positions along the diameter direction of this main holder 32, and a first auxiliary holder and a second auxiliary holder that can be received in these containing portions in a freely rotatable manner. Furthermore, first spinning shaft 42 is connected to first auxiliary motor M₁, second spinning shaft is connected to second auxiliary motor M₂, and two auxiliary holders, together with removable first chuck 42a and second chuck 44a, are installed on tips of these spinning shafts. In the figure, first chuck 42a is inserted into first joint 30 of first auxiliary holder 16, second chuck 44a is inserted into second joint 31 of the second auxiliary holder, and each spinning shaft and each auxiliary holder are thus coupled. Therefore, first target T₁ that is engaged to first auxiliary holder 16 can be rotated when first spinning shaft 32a is rotated by first auxiliary motor M₁, and in a similar manner, second target T₂ can be rotated by the drive of second auxiliary motor M₁. Furthermore, first slider S₁ that raises and lowers first spinning shaft 42 and second slider S₂ that raises and lowers second spinning shaft 44 are installed, and each independently can raise and lower first target T₁ and second target T₂.

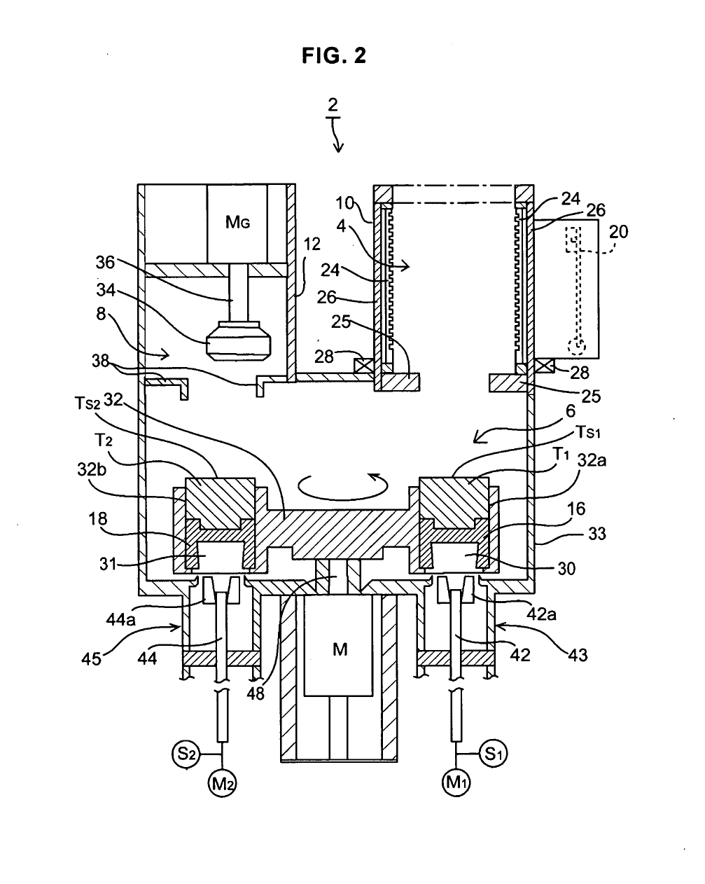

FIG. 2 is an apparatus cross-sectional view of target exchange type plasma generating apparatus 2 concerning the present invention, in a case that two auxiliary holders 16, 18 are received into main holder 32. Below, as for the reference numerals that have already been explained, their explanation is omitted. First spinning shaft 42 and second spinning shaft 44 are lowered by first slider S₁ and second slider S₂, with first chuck 42a and second chuck 44a in a closed state. Each chuck is pulled out of first joint 30 and the second joint, first auxiliary holder 16 is received in first containing portion 32a, and second auxiliary holder 18 in second containing portion 32b. Main holder 32 can half-rotate through main motor M as shown by the arrow, because each chuck 42a, 44a is located underneath the lowermost portion of main holder 32. Therefore, the target positions can be exchanged. These movement processes are described below.

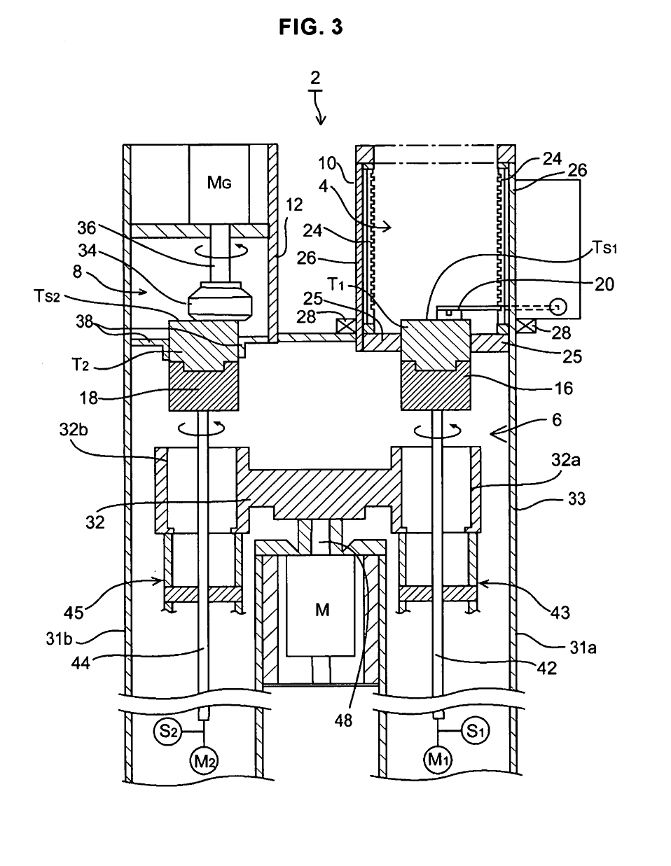

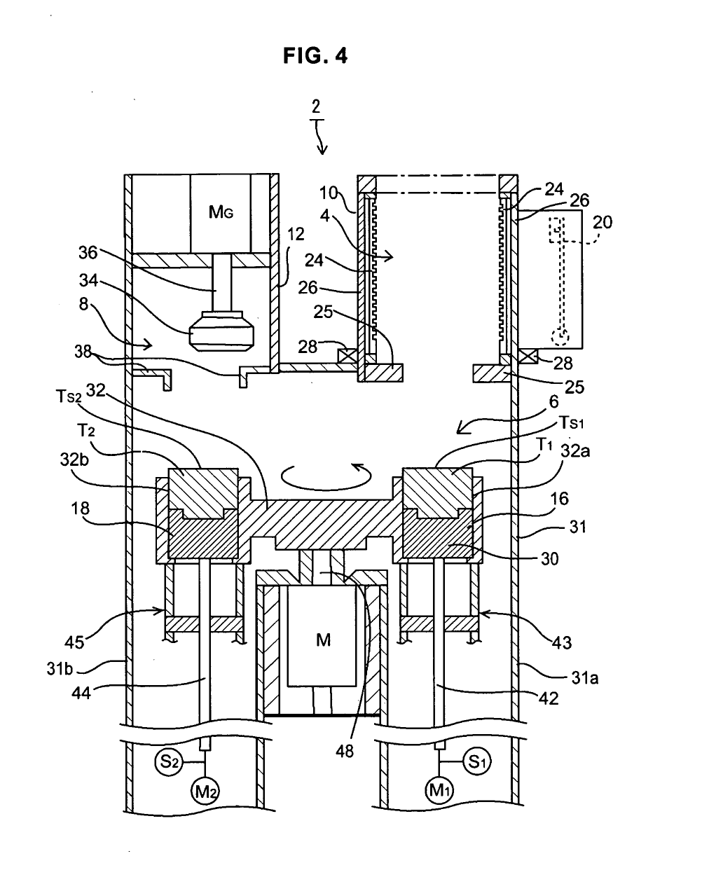

FIGS. 3 and 4 are apparatus cross-sectional views of target exchange type plasma generating apparatus 2 concerning the present invention, in a case that two holders 16, 18 are fixed to each spinning shaft 42, 44. In FIGS. 3 and 4, two auxiliary holder 16, 18 are fixed to each spinning shaft 42, 44. As shown in FIG. 4, auxiliary holders 16, 18 are contained in each containing portion 32a, 32b, and first and second spinning shafts 42, 44 end up rotating together with main holder 32 when the positions of first target T₁ and second target T₂ are exchanged. Therefore, spinning shaft outer walls 31a, 31b are also formed in the shape of a tube, so that each spinning shaft 42, 44 could rotate.

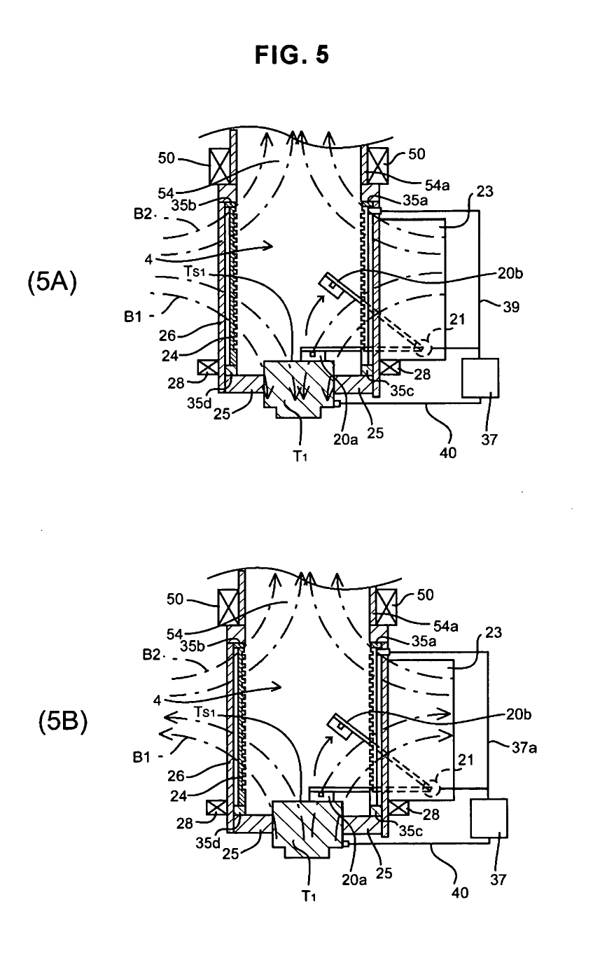

(5A) of FIG. 5 is a schematic cross-sectional view of the periphery of plasma generating portion 4 of target exchange type plasma generating apparatus 2 concerning the present invention. Voltage is applied by power supply 37 between anode inner wall 24/striker 20a and first target T₁ through electric wires 39, 40. Outer wall 26 does not come in contact with anode inner wall 24, and its electrical neutrality is maintained by insulation members 35a, 35b. A vacuum arc discharge is induced between electric discharge surface T_{S1} and anode inner wall 24 by separating striker 20a at the contact position toward the direction of the position of striker 20b. Striker 20a (or 20b) is installed on rotating means 21, and when striker 20b in a distant position is made to come in contact with electric discharge surface T_{S1}, the torque reaction force of striker 20a coming in contact is detected by rotating means 21, thereby allowing a determination that the striker is in contact condition. Furthermore, filter coil 50 is arranged at the plasma outlet side of plasma generating portion 4, and plasma advancing magnetic field B1 is formed. Stabilizing magnetic field B1 that is generated by target coil 28 is formed in reverse-phase (cusp) with respect to plasma advancing magnetic field B2, enabling a generation of stable plasma. As shown in (5B), it is found that when stabilizing magnetic field B1 that is generated by target coil 28 is in-phase (mirror), the stability of the arc spot decreases, but the generation efficiency of plasma is improved.

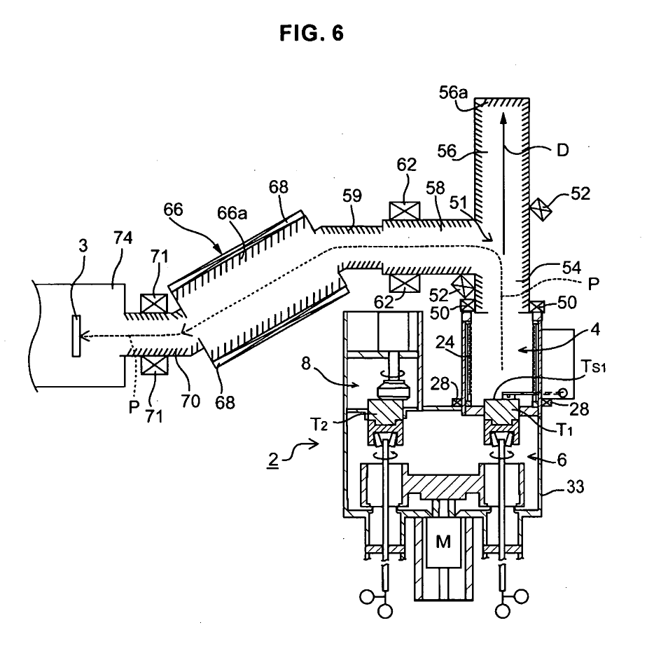

FIG. 6 is a schematic cross-sectional view of a plasma processing apparatus to which target exchange type plasma generating apparatus 2 concerning the present invention has been set up. At plasma generating portion 4, when vacuum arc plasma constituent particles such as target material ions, electrons, and cathode material neutral particles (atoms and molecules) are ejected by vacuum arc discharge, cathode material particles with size of less than submicron to several hundred microns (0.01-1000 μm) (henceforth referred to as “droplets D”) are also ejected at the same time. The generated plasma P advances through plasma advancing path 54, and advances to the second advancing path by means of a magnetic field formed in bending portion 51 by bending magnetic field generators 52, 52. At that time, because droplets D are electrically neutral and not affected by magnetic field, they advance straightly through droplet advancing path 56, and are collected by droplet collecting portion 56a. Also, in the inner walls of droplet advancing path 56 and each advancing path of plasma P, baffles 59 and 66a to which droplets D collide and adhere are installed.

In the second advancing path, a second magnetic field generator that generates a plasma advancing magnetic field is set up, and plasma P advances. It advances through radially enlarged tube 66 in which multiple baffles 66a are installed in the inner wall, remaining droplets D collide and adhere to said baffles 66a, and droplets D are removed furthermore. Plasma P from which droplets D have been removed is supplied to plasma processing portion 74 by the magnetic field of third magnetic field generator 71, 71, and a plasma treatment of object to be treated 3 can be done. In target exchange type plasma generating apparatus 2 concerning the present invention, because the generation of plasma and the polishing of the electric discharge surface can be repeated intermittently by exchanging the two targets, plasma treatment can be done highly efficiently.

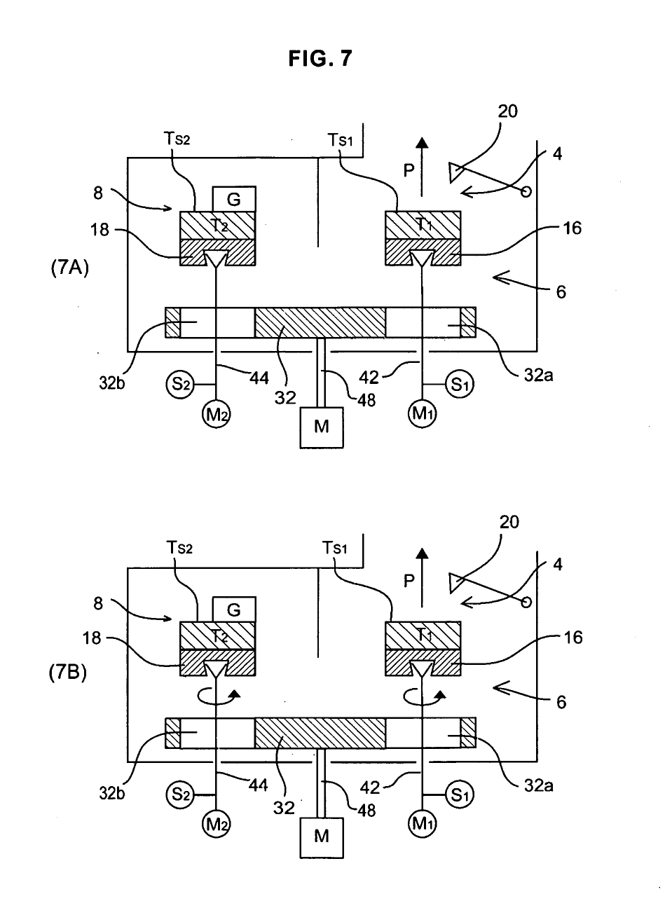

FIGS. 7 to 9 are explanatory drawings showing a movement process in target exchange type plasma generating apparatus 2 concerning the present invention, in a case in which each target T₁, T₂ is at the electric discharge position and the polishing position. In (7A), plasma P is generated while first target T₁ is in the electric discharge position of plasma generating portion 4. Second target T₂ is in the polishing position of target polishing portion 8, and it is ground by grinder G until electric discharge surface T_{S2} becomes an even plane. When the pore of electric discharge surface T_{S1} formed by generation of plasma P enlarges, and the generation efficiency of the plasma by the vacuum arc discharge falls, the first spinning shaft spins by the drive of motor M₁, the first target also spins through the first auxiliary holder, and it becomes possible for striker 20 to come in contact at a new position of electric discharge surface T_{S1}, as shown in (7B). Therefore, the generation efficiency of the plasma recovers, and plasma P of specified quantity can be generated. Therefore, on the electric discharge surface of first target T₁, multiple pores are formed. On the other hand, in target polishing portion 8, the position in which grinder G comes in contact with electric discharge surface T_{S2} can be changed by the spinning of second target T₂, and even if multiple pores are formed in second target T₂, these pores can be removed by grinding in grinder G.

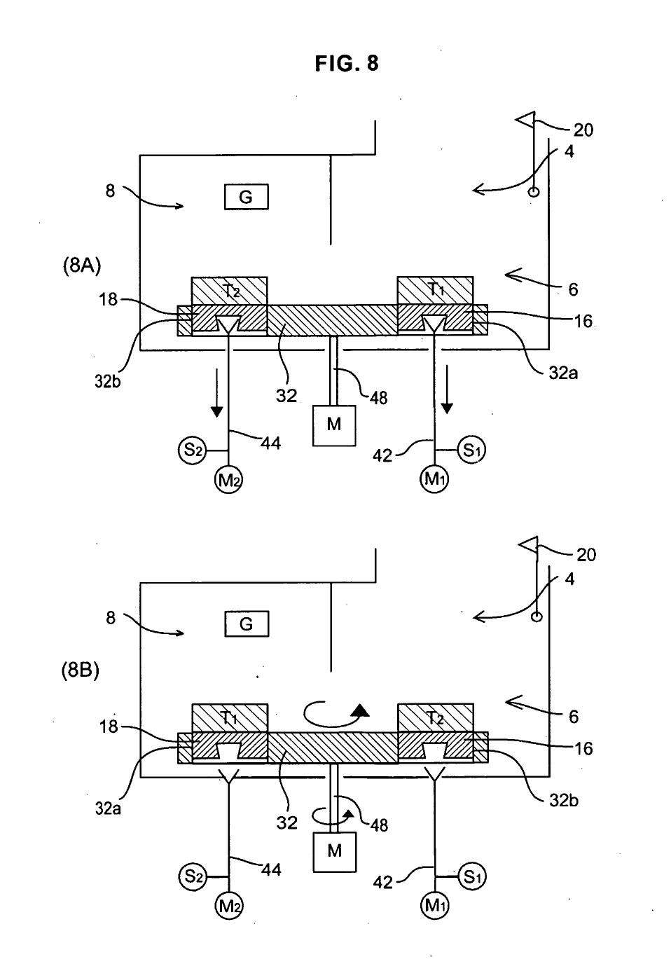

In (8A) of FIG. 8, target T₁ that has been fixed to first holder 16 and target T₂ that has been fixed to second holder 18 are lowered by sliders S₁, S₂, and are contained in each containing portion 32a, 32b of main holder 32. (8B) shows a condition in which each spinning shaft is lowered further from the state of (8A), and main holder 32 has been half-rotated by main motor M. The positions of each target and each auxiliary holder are exchanged.

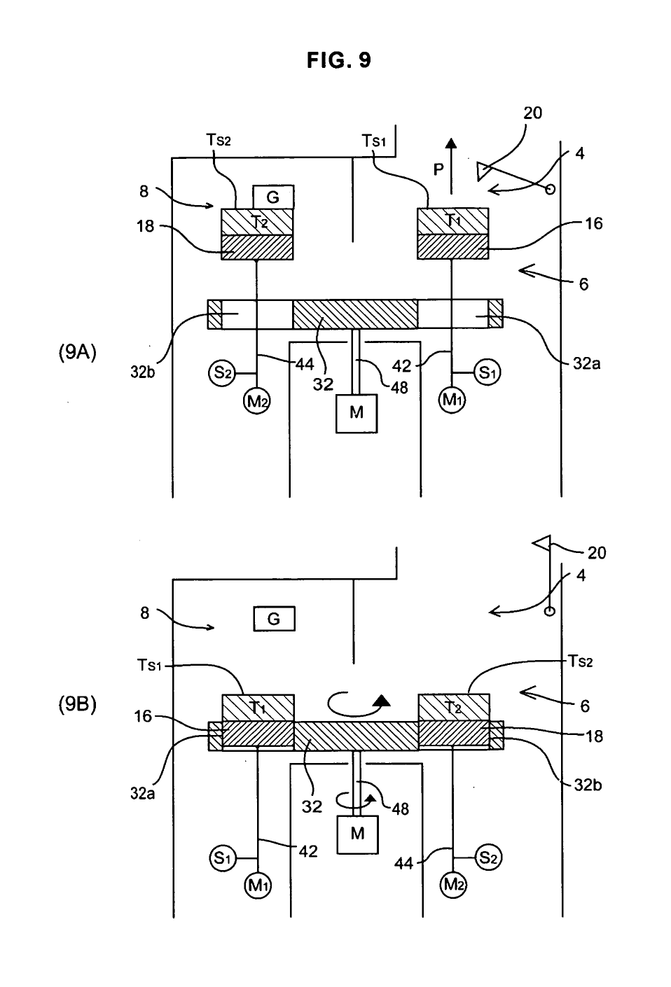

FIG. 9 is an explanatory drawing concerning the present invention, showing the movement process in a case where each spinning shaft is fixed to an auxiliary holder. The embodiment shown in FIG. 9 corresponds to the target exchange type plasma generating apparatus shown in FIGS. 3 and 4. Each target T₁, T₂ is lowered by each slider S₁, S₂ from the electric discharge position and the polishing position shown in (9A), contained in main holder 32, and half-rotated. In this case, the positions of each spinning shaft 42, 44, each auxiliary motor M₁, M₂, and each slider S₁, S₂ are also exchanged.

The present invention is not limited to the embodiments described above. Various modifications, design alterations, and others that do not involve a departure from the technical concept of the present invention are also included in the technical scope of the present invention.

### INDUSTRIAL APPLICABILITY

According to target exchange type plasma generating apparatus concerning the present invention, a target exchange type plasma generating apparatus can be offered, in which the positions of the depleted target, to which multiple pores have been formed by plasma generation, and the polish-processed target can be exchanged, and also, the height of the two targets, and their contact position with the striker and such can be adjusted independently. For example, in a case where two kinds of target with different composition are set up, a target can be installed in a suitable location, depending on the quantity of consumption. Therefore, according to the present invention, vacuum arc plasma can be generated without opening the vacuum chamber, for a long time, continually or intermittently, and more stably, and thus a plasma processing apparatus that highly efficiently performs a film formation and a plasma treatment to an object to be treated can be provided.

1. A target exchange type plasma generating apparatus comprising
a plasma generating portion that generates plasma by a vacuum arc discharge between a target becoming a cathode and an anode under a vacuum environment,
a target polishing portion that polishes an electric discharge surface of said target, and
a target exchanging mechanism that exchanges the positions of a target positioned at an electric discharge position of said plasma generating portion and a target positioned at a polishing position of said target polishing portion, wherein
said target exchanging mechanism comprises
a main holder half-rotated by a main motor,
two containing portions installed in opposite positions along the diameter direction of said main holder,
two auxiliary holders contained rotatably in said two containing portions,
two auxiliary motors spinning said two auxiliary holders,
two sliders raising and lowering said two auxiliary holders in the spinning shaft direction, and
said two targets engaged in said two auxiliary holders, where
the positions of said targets are exchanged by half-rotating said main holder, and said two targets are independently driven so that they are raised, lowered, and spun to said electric discharge position and said polishing position when said main holder is stationary.

2. The target exchange type plasma generating apparatus according to claim 1, wherein
connecting means removable from said auxiliary holders are installed at tips of said spinning shafts,
said auxiliary motors and said sliders are separated from said main holder at the detachment time of said connecting means,
the positions of said targets are exchanged by half-rotating only said main holder that has received said auxiliary holders,
said auxiliary holders are separated from said main holder by raising said spinning shafts at the engagement time of said connecting means, and
each of said two targets are independently deployed at said electric discharge position and said polishing position.

3. The target exchange type plasma generating apparatus according to claim 2, wherein said connecting means comprises a chuck mechanism.

4. The target exchange type plasma generating apparatus according to claim 1, wherein
said auxiliary holders are fastened to tips of said spinning shafts,
each of said two targets are positioned independently at said electric discharge position and said polishing position by raising said spinning shafts and separating said auxiliary holders from said main holder,
said auxiliary holders are contained inside said containing portions of said main holder by lowering said spinning shafts, and
said auxiliary motors and said sliders are half-rotated as a whole upon exchanging the positions of said targets by half-rotating said main holder.

5. The target exchange type plasma generating apparatus according to any one of claims 1-4, wherein
said plasma generating portion is positioned in a plasma generation chamber sealed by an electric discharge partition wall when said target is positioned at said electric discharge position,
said target polishing portion comprising a polishing device is positioned in a target polishing chamber sealed by a polishing partition wall when said target is positioned at said polishing position, and
ground powder that is ejected by said polishing device from said target is sealed in said polishing chamber.

6. The target exchange type plasma generating apparatus according to any one of claims 1-4, wherein said plasma generating portion is formed inside of an electrically neutral outer wall and an anode inner wall installed at the inner side of said outer wall.

7. The target exchange type plasma generating apparatus according to claim 6, wherein
a target coil is positioned at the outer circumference of said outer wall tube at a vicinity position of said target,
a filter coil is positioned at the plasma outlet side of said plasma generating portion, and
a stabilizing magnetic field that is generated by said target coil is formed in reverse-phase (cusp) or in-phase (mirror) of a plasma advancing magnetic field that is generated by said filter coil.

8. The target exchange type plasma generating apparatus according to any one of claims 1-4, wherein
a striker that induces an arc discharge on said electric discharge surface of said target is positioned at a vicinity of the target positioned at said electric discharge position of said plasma generating portion,
said striker is rotated around a fulcrum by a rotating means, and
abutting of said striker tip against said electric discharge surface is detected by measuring the torque reaction force on said striker.
